(19) United States
(12) Patent Application Publication
(10) Pub. No.: US 2014/0372202 A1
(43) Pub. Date: Dec. 18, 2014

(54) PREDICTING PERFORMANCE OF CONTENT ITEMS USING LOSS FUNCTIONS

(71) Applicant: Google Inc., Mountain View, CA (US)

(72) Inventors: Patrick Hummel, Cupertino, CA (US); Randolph P. McAfee, San Marino, CA (US)

(21) Appl. No.: 13/919,600

(22) Filed: Jun. 17, 2013

(51) Int. Cl. G06Q 30/02

(52) U.S. Cl. CPC G06Q 30/0242; G06Q 30/0273
USPC 705/14.41

(57) ABSTRACT

Methods, systems, and apparatus, including computer programs encoded on a computer storage medium, for providing a content item. In one aspect, a method includes receiving a content item request. A set of candidate content items that are eligible to be provided in response to the content item request is identified. A performance measure is predicted for each candidate content item based at least in part on a loss function that specifies an economic cost of incorrectly predicting the performance measure for the candidate content item. The loss function can be based in part on a distribution of competing bid values for a set of previous content item impressions. A candidate content item can be selected for presentation based on the predicted performance measure for the candidate content items. The selected candidate content item is provided in response to the content item request.

### BACKGROUND

This specification relates to data processing and content distribution.

The Internet enables access to a wide variety of resources. For example, video, audio, web pages directed to particular subject matter, news articles, images, and other resources are accessible over the Internet. The wide variety of resources that are accessible over the Internet has enabled opportunities for content distributors to provide content items with resources that are requested by users. Content items are units of content (e.g., individual files or a set of files) that are presented in/with resources (e.g., web pages). An advertisement is an example of a content item that advertisers can provide for presentation with particular resources, such as web pages and search results pages. An advertisement can be made eligible for presentation with specific resources and/or resources that are determined to match specified distribution criteria, such as distribution keywords.

### SUMMARY

In general, one innovative aspect of the subject matter described in this specification can be embodied in methods that include the actions of receiving a content item request; identifying a set of candidate content items that are eligible to be provided in response to the content item request; predicting a performance measure for each of one or more candidate content items based at least in part on a loss function that specifies an economic cost of incorrectly predicting the performance measure for the candidate content item, the loss function being based, at least in part, on a distribution of competing bid values for a set of previous content item impressions; selecting a candidate content item for presentation based, at least in part, on the predicted performance measure for the one or more candidate content items; and providing the selected candidate content item in response to the content item request. Other embodiments of this aspect include corresponding systems, apparatus, and computer programs, configured to perform the actions of the methods, encoded on computer storage devices.

These and other embodiments can each optionally include one or more of the following features. Aspects can further include selecting the loss function for the one or more candidate content items based on a category corresponding to the one or more candidate content items. The distribution of competing bid values can include bid values received for previous impressions of content items that were included in the category. Aspects can further include determining the loss function using an integral of the distribution of competing bid values for the set of previous content item impressions.

The loss function can be further based on a bid value for a particular candidate content item. The bid value for the particular candidate content item can specify a value a provider of the particular content item is willing to pay for user interaction with the particular candidate content item in response to the content item request. The content item request can include a request for a content item for display on a resource that includes two or more content item slots. The loss function generated for the particular content item can be based on a set of probability values. Each probability value can be associated with a particular content item slot of the two or more content item slots and indicate a probability that a product of a predicted performance measure for the particular content item and the bid value for the particular content item is between a highest bid value for the particular content item slot and a next highest bid.

The loss function can specify a greater economic cost for an under-prediction of the performance measure by a particular amount than an economic cost for an over-prediction of the performance measure by the particular amount for bid values that are greater than a threshold bid. The loss function can specify a greater economic cost for an over-prediction of the performance measure by a particular amount than an economic cost for an under-prediction of the performance measure by the particular amount for bid values that are less than a threshold bid.

Aspects can further include selecting the loss function to train the predictive model from a set of loss functions based on a number of content item slots included on a resource for which the selected candidate content item is provided. Predicting the performance measure for a particular candidate content item can include identifying a predictive model that has been trained using at least the loss function to reduce an expected economic cost resulting from incorrectly predicting the performance measures for the content items and applying the predictive model to feature values of the particular content item. The feature values can specify features of the particular content item.

Particular embodiments of the subject matter described in this specification can be implemented so as to realize one or more of the following advantages. Performance measures for content items (e.g., online advertisements) can be predicted using loss functions that estimate the economic cost that will occur if the prediction is inaccurate. Loss functions described herein can better predict the real economic impact of inaccurately predicting performance measures for content items, for example when the predicted performance measures are used in an auction process to select a content item for presentation. Generating loss functions based on a distribution of competing bids enable the loss functions to better reflect the true economic costs of mispredicting performance measures in an auction process. A loss function can be selected based on the number of content item slots included in an advertisement auction and/or data that is available or desired for use in predicting the performance measure for a content item so that the economic impact is determined in the context of the presentation environment.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a content distribution system distributes content to user devices.

FIG. 2 is a graph of an example loss function.

FIG. 3 is a flow chart of an example process for generating a loss function.

FIG. 4 is a flow chart of an example process for providing a content item.

FIG. 5 is block diagram of an example computer system.

Like reference numbers and designations in the various drawings indicate like elements.

### DETAILED DESCRIPTION

Models that are trained using loss functions can be used to predict performance measures for content items (e.g., online advertisements, audio files, and/or video files). In turn, the predicted performance measures can be used, for example, in combination with bids, to rank content items for selection in response to a content item request. For example, advertisements may be selected for presentation in response to an advertisement request based on predicted performance measures and bids for the advertisements.

A loss function estimates the economic cost that may result from incorrectly predicting the performance measure for a content item in the context of a content item selection process. For example, there may be an economic cost that results from over-predicting a click-through rate for advertisement A if the over-prediction causes advertisement A to be presented in place of advertisement B although a user was actually more likely to interact with advertisement B than advertisement A (e.g., advertisement B turns out to have a higher actual click-through rate than advertisement A or advertisement B would have been selected and advertisement A was not selected). The loss function can quantify the economic cost caused by the inaccurate prediction, for example, in terms of dollars or in terms of economic efficiency.

A loss function can be used in combination with other data to train a model that predicts performance measures for content items. For example, a machine learning system may train a model using characteristics of content items that have known performance measures, the known performance measures, characteristics of the content item slots in which they were presented (e.g., data regarding a resource having the slots or the resource's publisher), and a loss function. Using a loss function, the machine learning system can train the model to reduce or minimize potential economic costs that may result from mispredicting the performance measure for content items. Once trained, the machine learning system can predict the performance measure of a content item by applying a trained model to characteristics of the content item and/or the content item slot for which the content item may be presented.

A loss function can be based on a distribution of competing bids for previous content item impressions. A previous content item impression is a particular display of the content item, for example, on a web page or other resource. The distribution of competing bids can include winning and non-winning bids for content items that were in competition (e.g., in an auction) for the impression. The distribution of competing bids may include those that were high enough to compete, e.g., bids that were within a threshold of the winning bid for the content item impression.

The distribution of competing bids indicates which bids were competitive and can indicate a range of bids where an inaccuracy in prediction of a performance measure may result in a highest economic cost. For example, underpredicting a performance measure for content item having a bid that is less than other competing bids is unlikely to have an associated economic cost as the content item was unlikely to be selected even if the predicted performance measure was accurate. Conversely, underpredicting a performance measure for a content item having a bid that is within (or at the top of) the range of competing bids may result in an economic cost as the content item may have been selected if not for the underprediction. As described below, predicting content item performance based, at least in part, on a loss function can help reduce the economic costs associated with inaccurate predictions.

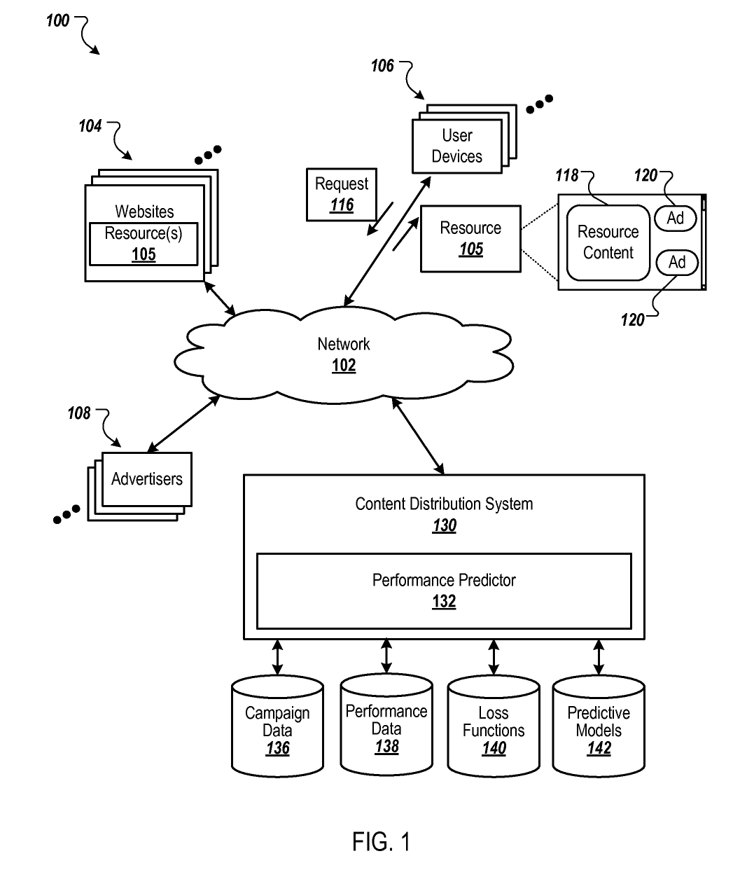

FIG. 1 is a block diagram of an example environment 100 in which a content distribution system 130 distributes content to user devices 106. The example environment 100 includes a network 102 such as a local area network (LAN), wide area network (WAN), the Internet, or a combination thereof. The network 102 connects websites 104, user devices 106, advertisers 108, and the content distribution system 130. The example environment 100 may include millions of websites 104, user devices 106, and advertisers 108.

A website 104 is one or more resources 105 associated with a domain name and hosted by one or more servers. An example website is a collection of web pages formatted in hypertext markup language (HTML) that can contain text, images, multimedia content, and programming elements, e.g., scripts. Each website 104 is maintained by a publisher, e.g., an entity that manages and/or owns the website 104.

A resource 105 is data provided by the website 104 over the network 102 and that is associated with a resource address. Resources include HTML pages, word processing documents, and portable document format (PDF) documents, images, video, and feed sources, to name only a few. The resources can include content 118, e.g., words, phrases, images and sounds that may include embedded information (such as meta-information in hyperlinks) and/or embedded instructions (such as scripts).

A user device 106 is an electronic device that is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can include resource content 118 (e.g., text, images, videos, etc. of the resource 105) and content item slots 120 (e.g., advertisement slots). When a resource 105 having a content item slot 120 is requested by a user device 106, the content distribution system 130 receives a content item request 116 requesting content items to be provided with the resource content 118.

A content item request 116 can include data regarding the content item slots 120 (e.g. size or type of content item slot), data regarding the resource 105 on which the content item will be presented (e.g., category or keywords found on the resource, data regarding publisher of resource, etc.), and/or other data. If the content items are to be presented in content item slots 120 of a search results page, the content item request 116 may include keywords of a search query submitted to a search system.

The content distribution system 130 allows advertisers 108 to define campaign rules that take into account attributes of content item slots and resources on which content items (e.g., advertisements) are to be presented. Example campaign rules include keyword rules, in which an advertiser 108 provides bids for keywords that are present in either search queries or resource content 118. A bid represents a value that an advertiser 108 is willing to pay in response to a presentation of the advertisement or an interaction (e.g., click or selection) with the advertisement. Advertisements that are associated with keywords having bids that result in a content item slot 120 being awarded in response to an auction are selected for displaying in the content item slots 120. Example processes for selecting advertisements (or other content items) for display in content item slots 120 based on bids and predicted performance measures are described in detail below.

When a user of a user device 106 selects an advertisement, the user device 106 generates a request for a landing page of the advertisement, which is typically a web page of the advertiser 108. For example, the advertisers 108 may each have respective web pages, some of which are landing pages for the advertisements of the advertisers 108.

The content distribution system 130 includes a data storage system that stores campaign data 136, performance data 138, loss functions 140, and predictive models 142. The campaign data 136 stores content items (e.g., advertisements), campaign information, bid values for content items, and budgeting information for advertisers 108. The performance data 138 stores data indicating the performance of the content items that are served. Such performance data can include, for example, click-through rates for content items, the number of impressions for content items, the number of conversions for content items (e.g., purchase of a product in response to the display of an advertisement), and bid values for previous content item impressions (e.g., winning and non-winning bids). Other performance data can also be stored.

The content distribution system 130 also includes a performance predictor 132 that predicts or estimates performance measures (e.g., click-through rates or conversion rates) for content items. As described in more detail below, the performance predictor 132 can train predictive models 142 to predict performance measures for content items using loss functions. Once trained, the performance predictor 132 can predict the performance measure for a content item by applying a predictive model 142 to feature values for features of the content item and/or features of content item slots in which the content item may be presented.

The predicted performance measures and campaign data 136 are used as input parameters to an auction or another content item selection process. For example, the content distribution system 130, in response to each request for advertisements (or other content items), can conduct an auction to select advertisements (or other content items) that are provided in response to the request. The advertisements are ranked according to a rank score that, in some implementations, is proportional to a value using a bid and a predicted performance measure. The one or more highest ranked advertisements resulting from the auction are selected and provided to the requesting user device.

The performance predictor 132 can train predictive models 142 to predict performance measures for content items using feature values for content items, known performance measures for the content items, feature values for content item slots in which they were presented (e.g., features of a resource having the slots or the resource's publisher), and a loss function 140. For example, the performance predictor 132 may train a logistic regression model using the data. Using the loss function 140, the performance predictor 132 can train the model to reduce or minimize potential economic costs that may result from mispredicting the performance measure of the content items.

In general, a feature value of a content item is a value indicative of a feature of the content item. For example, a feature value for a content item may specify the type of content item. The features of the content item can include the type of content item (e.g., text, image, video, etc.), a topic or category of the content item (e.g., sports, travel, cooking, etc.), and/or features of the content item provider. The feature values of the content item slot can include values representing features of the resource 105, such as the topic of the resource, the type of content displayed by the resource, and/or the number of content item slots included in the resource 105. The feature values of the content item slot can also represent features of the publisher of the resource 105 that includes the content item slots.

Training the predictive models 142 can include determining coefficients for various features of content items and/or content item slots. The performance predictor 132 can predict the performance of a content item by applying a trained predictive model 142 to feature value of a content item and/or feature values of a content item slot in which the content item may be presented. For example, the performance predictor may apply the coefficients to the corresponding feature values and determine the predicted performance measure using the results.

Each loss function 140 specifies an estimate of the economic cost that may result from incorrectly predicting the performance measure for a content item. For example, each loss function 140 may map estimated dollar losses or efficiency losses to differences between a predicted performance measure (e.g., click-through rate or conversion rate) and an actual performance measure for a content item.

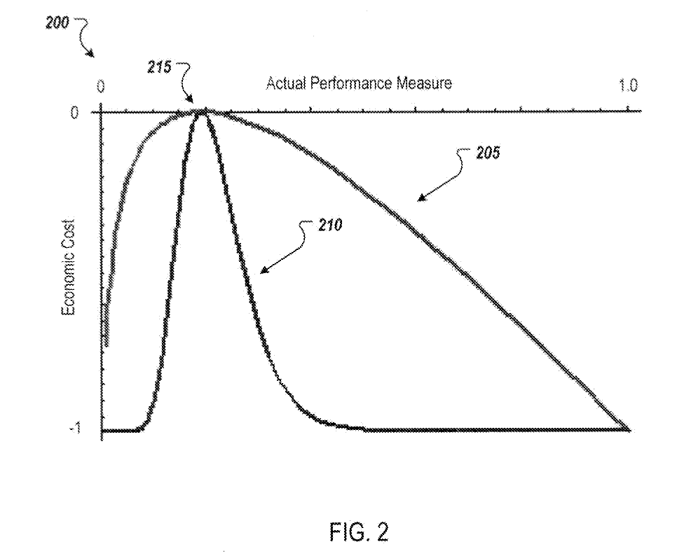

FIG. 2 is a graph depicting example loss functions 205 and 210. The loss functions 205 and 210 indicate an expected economic cost associated with various differences between predicted and actual performance measures. In this example graph, an economic cost of “0” represents the minimum economic cost and an economic cost of “−1” represents the maximum economic cost. The point 215 represents a predicted performance measure (e.g., as predicted by the performance predictor 132) and the lines for each loss function 205 and 210 depict the expected economic cost that will be incurred for a range of actual performance measures. In this example, the predicted performance measure is about “0.2” and both loss functions 205 and 210 have an expected economic cost of about “0” when the actual performance measure is also “0.2.” However, the expected economic cost specified by the two loss functions 205 and 210 differ for actual performance measures that are less than or greater than the predicted performance measure.

The loss function 205 represents a log likelihood loss function. This example loss indicates significantly larger economic costs for large mispredictions than for small mispredictions. In contrast to the loss function 205, the loss function 210 is based on a distribution of competing bids for previous content item impressions. The loss function 210 indicates similar economic costs for mispredictions that are off by more than a particular fixed amount. For example, the economic cost of overpredictions that are greater than “0.3” is about “−1.0.” Similarly, underpredictions of “0.1” or more result in an economic cost of “−1.0” for the loss function 210.

The loss function 210 more accurately reflects the true economic cost that results from making inaccurate predictions of performance measures in a content item auction than the loss function 205. One reason for this is that if the performance predictor 132 makes a very inaccurate prediction, making a prediction that is even more inaccurate is unlikely to have an effect on the outcome of an auction. For example, if the performance predictor 132 predicts that an advertisement's click-through rate is only 1/100 as large as the advertisement's actual click-through rate, then this advertisement will likely not be among the two highest bidders in an auction (e.g., an auction that ranks advertisements based on bid values and predicted click-through rates) regardless of how much more the advertisement's click-through rate is underpredicted. Thus, the economic cost should generally not continue to increase when the magnitude of an underprediction increases. However, if the predicted click-through rate for the advertisement is close to the advertisement's actual click-through rate, then further mispredicting the click-through rate of the advertisement is more likely to have an effect on the outcome of the auction because the advertisement is more likely to be in a situation where changes in the predicted click-through rate will affect its allocation in the auction. Thus, the economic cost depicted by the loss function 210 increases sharply as the actual performance measure moves from the predicted performance measure and essentially levels out not far from the value of the predicted performance measure.

To predict the economic cost of mispredicting performance measures, each loss function 140 of FIG. 1 may be based on a distribution of competing bids for previous content item impressions, similar to the loss function 210 illustrated in FIG. 2. The previous content item impressions used to generate the distribution of bids can be selected based on a level of abstraction for the loss function. For example, a single loss function may be generated for all content items identified in the campaign data 136, a separate loss function may be generated for each advertiser 108, or loss functions can be generated at various levels in between. The previous content item impressions used to generate a loss function for the entire campaign data could include all previous impressions for content items included in the campaign data 136. Similarly, the previous impressions used to generate a loss function for a particular advertiser may only include the previous impressions of the advertiser's content items.

Loss functions 140 can also be generated for “buckets” or “categories” of content items, which can include any proper subset of available content items. For example, the loss functions 140 may be generated for topic-based categories. In this example, there may be a loss function 140 for content items classified as relating to a sports category, and another loss function 140 for content items classified as relating to a travel category. The previous content item impressions used to generate the loss function 140 for the sports category may include previous impressions of sports-related content items (e.g., those classified in the sports category).

Loss functions 140 may also be created for categories that are based on a type of user device (e.g., tablet, smart phone, or notebook computer), type of content item (e.g., text, image, or video), time and date (e.g., time of day, season, or day of week), geographic location of a user device (e.g., city, state, region, or country), resource publisher, or other characteristics, or a combination of characteristics. For example, a loss function 140 may be generated for travel-related content items that are to be shown on a tablet computer. The previous content item impressions used to generate such a loss function may include previous impressions of travel-related content items that occurred on a tablet computer.

The content distribution system 130 can obtain previous bid data for the set of previous impressions that is going to be used to generate the loss function, for example, from the performance data 138. The bid data can include, for each previous content item impression, the winning bid and each non-winning bid. The distribution of competing bids used to create a loss function may be limited to bids that were high enough to be competitive. For example, if a content item slot was won based on a bid of two dollars, then a bid of ten cents may be excluded as the bid was not likely to win the content item slot. The content distribution system 130 can select bids to include in the distribution of competing bids using a threshold. For example, the content distribution system 130 may only include in the distribution of bids those that were within a threshold amount (e.g., within an absolute value of or within a specified percentage) of the winning bid for a content item impression.

Some example loss functions that are based on a distribution of competing bids are provided below. The example loss functions estimate the economic cost of mispredicting a click-through rate for an advertisement in an advertisement auction where advertisements are ranked based on an expected cost-per-1000-impressions (“eCPM bid”). The eCPM bid for an advertisement is equal to (or proportional to) a product of a predicted click-through rate for the advertisement and a cost-per-click (“CPC”) bid for the advertisement. Although the example loss functions are related to eCPM bids for advertisement auctions, the loss functions can be used or adapted for use in minimizing or reducing the economic cost of mispredicting other performance measures and for other types of content items.

Loss function (1), shown below, can be used to reduce or minimize the economic cost resulting from predicting click-through rates incorrectly in a single-slot advertisement auction. A single-slot advertisement auction is an auction to select an advertisement for a single advertisement slot of a resource. The example loss function (1) can be used for auctions where the loss function may depend on the bid of the advertiser and the actual click-through rate of the advertisement.

Loss Function:∫_{bp}^{bq}(bp−A)g(A|b)dA (1)

In loss function (1), variable “b” is the actual bid amount for a content item, variable “q” is the predicted click-through rate for the advertisement, variable “p” is the actual click-through rate for the advertisement, “g(A|b)” is the probability density function that corresponds the cumulative distribution function “G(A|b)” for competing eCPM bids for previous advertisement impressions, and variable “A” is the highest competing eCPM bid that the advertiser faces. The highest competing eCPM bid that the advertiser faces is a random draw from the cumulative distribution function. The cumulative distribution is generated using the competing eCPM bids selected for use in the loss function.

As the loss function (1) can be used for multiple content items and be generated in advance of an auction, the bid value “b” may be for a particular content item or representative of bid values for multiple content items. For example, the bid value “b” may be based on an average of bid values for content items for which the loss function may be used in predicting performance measures.

As the loss function (1) is based on a bid value “b”, the economic cost estimated by the loss function (1) (and thus, the curve of the loss function itself) may vary based on where the bid value “b” falls relative to the distribution of competing bids. For example, if the bid value is greater than a threshold bid (e.g., the eCPM bid or a bid at or near the middle of the distribution of competing bids), then an underpredition of the performance measure may be penalized more heavily than an overprediction of the performance measure as the underprediction may prevent the display of a content item that would be displayed if not for the misprediction. Thus, the slope of the loss function for underpredictions (e.g., moving to the left along the graph 200 from the point 215) may be steeper than the slope of the loss function for overpredictions (e.g., moving to the right along the graph 200 from the point 215). In such an example, the loss function may specify a greater economic cost for an underprediction for the performance measure by a particular amount than an economic cost for an overprediction of the performance measure by the particular amount for bid values “b” that are greater than the bid threshold.

Similarly, if the bid value “b” is less than a threshold bid (e.g., a bid near the middle of the distribution of competing bids or the lowest competing bid), then an overprediction of the performance measure may be penalized more heavily than an underprediction of the performance measure as the overprediction may cause the display of a content item that would not be displayed if not the misprediction. Thus, the slope of the loss function for overpredictions (e.g., moving to the right along the graph 200 from the point 215) may be steeper than the slope of the loss function for underpredictions (e.g., moving to the left along the graph 200 from the point 215). In such an example, the loss function may specify a greater economic cost for an overprediction for the performance measure by a particular amount than an economic cost for an underprediction of the performance measure by the particular amount for bid values “b” that are greater than the bid threshold.

Loss function (2), shown below, can be used to reduce or minimize the economic cost resulting from predicting click-through rates incorrectly in single-slot auctions where the loss function may depend on the actual click-through rate of the advertisement, but not the bid value of the advertiser.

Loss Function:∫₀^{∞}∫_{bp}^{bq}(bp−A)g(A|b)dAdH(b) (2)

In loss function (2), “H(b)” denotes the cumulative distribution function corresponding to the CPC bids for previous advertisement impressions. The other variables match those of loss function (1) described above.

Loss function (3), shown below, can be used to reduce or minimize the economic cost resulting from by predicting click-through rates incorrectly in single-slot auctions where the loss function may depend on the bid value of the advertiser, but not the actual click-through rate of the advertisement.

Loss Function:∫_{bc}^{bq}(bc−A)g(A|b)dA (3)

In loss function (3), the variable “c” is a dummy variable that equals “1” if the advertisement received a user interaction (e.g., selection) and “0” otherwise.

To reduce the computational complexity of loss function (3), the probability density function “g(A|b)” can be replaced with a probability density function “\tilde{g}′” that satisfies relationships (1) and (2) below:

$$\begin{matrix}Relationship \text{:} {\tilde{g}}^{′} ( bq \vert b ) \leq \frac{\tilde{g} ( bq \vert b )}{b ( 1 - q )} & ( 1 ) \\ Relationship \text{:} {\tilde{g}}^{′} ( bq \vert b ) \geq \frac{\tilde{g} ( bq \vert b )}{bq} & ( 2 )\end{matrix}$$

In multi-slot position auctions, there are a total of “s” positions on a resource where advertisements can be displayed. Each position “k” has some click-through rate “xₖ” that reflects the relative number of clicks that an advertiser can expect to receive if the advertiser has its advertisement displayed in position “k”. The “s” highest competing eCPM bids that this advertiser faces are a random draw from the cumulative distribution function “G(v₁, . . . , vₛ|b)” with corresponding probability function “g(v₁, . . . , vₛ|b)”, where vₖ denotes the k^{th}-highest bid submitted by another advertiser.

Loss function (4), shown below, can be used to reduce or minimize the economic cost resulting from by predicting click-through rates incorrectly in a multi-slot position auction where the loss function may depend on the bid of the advertiser and the actual click-through rates of the advertisements.

Loss Function:pu(q)−c(q),where:

u(q)=Σₖ₌₁^{s}bxₖPr(νₖ₋₁>bq≧νₖ|q),

c(q)=∫₀^{q}yu′(y)dy (4)

In loss function (4), “Pr(νₖ₋₁>bq≧νₖ|q)” denotes the probability that “bq” will fall between “νₖ₋₁” and “νₖ”. Thus, “Pr(νₖ₋₁>bq≧νₖ|q)” for each position “k” denotes that probability that “bq” (product of the bid and predicted click-through rate) will have a value between the highest eCPM bid for position “k” and the highest eCPM bid for the position “k−1”. In the case where k=1, “Pr(νₖ₋₁>bq≧νₖ|q)” denotes the probability that “bq” will have a value greater than or equal to the highest eCPM bid for position 1.

Loss function (5), shown below, can be used to reduce or minimize the economic cost resulting from predicting click-through rates incorrectly in a multi-slot position auction where the loss function may depend on the bid of the advertiser, but not the actual click-through rates of the advertisements.

Loss Function:∫_{c}^{q}(c−y)u′(y)dy,where:

u(q)=Σₖ₌₁^{s}bxₖPr(νₖ₋₁>bq≧νₖ|q) (5)

In loss function (5), the variable “c” is a dummy variable that equals “1” if the advertisement received a click and “0” otherwise.

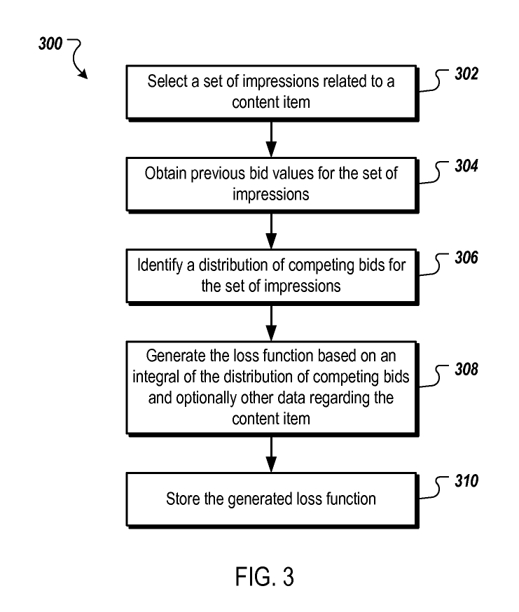

FIG. 3 is a flow chart of an example process 300 for generating a loss function. Operations of the process 300 can be implemented, for example, by a data processing apparatus, such as the content distribution system 130 of FIG. 1. The process 300 can also be implemented by instructions stored on computer storage medium, where execution of the instructions by a data processing apparatus cause the data processing apparatus to perform the operations of the process 300.

A set of previous content item impressions is identified (302). As described above, the previous content item impressions included in the set can vary based on the level of abstraction desired for the loss function or a category for which the loss function is being generated. For example, if a loss function is being generated for sports-related content items that will be shown on a tablet computer, the set of previous content item impressions may include impressions of sports-related content items that were displayed on a tablet computer.

Previous bid values are obtained for each impression of the set of previous impressions (304). The previous bid values for an impression may include the winning bid and each other bid that was included in an auction for the impression. The content distribution system 130 may obtain the bid values from the performance data 138.

A distribution of competing bids is identified for the set of impressions (306). In some implementations, the content distribution system 130 identifies a set of competing bids for each previous impression and includes each set of competing bids in the distribution of bids. For each previous impression, the content distribution system 130 may identify for inclusion in the distribution of competing bids the winning bid and each bid that is within a threshold amount of the winning bid. For example, if the winning bid for an impression is three dollars and the threshold is fifty cents, bid values that range from two dollars and fifty cents to three dollars may be included in the distribution of competing bids.

A loss function is generated based on the distribution of competing bids (308). In some implementations, the loss function is based on an integral using the distribution of competing bids and other data (e.g., bid value for the content item, click-through rates of content items, highest competing bid, etc.), as shown above in the example loss functions. In some implementations, the content distribution system 130 generates a probability distribution function using the distribution of competing bids. The content distribution system 130 may generate the loss function based on an integral of the probability density function and optionally other variables, as described above with reference to the example loss functions (1)-(5).

The generated loss function is stored (310). The content distribution system 130 may store the loss function in a data storage unit. In response to a content item request being received, the content distribution system 130 may access the loss function (or a predictive model generated using the loss function) and use the loss function (or predictive model) to predict a performance measure for a content item.

As described above, the loss functions can be used to generate predictive models 142 that can, in turn, be used to predict a performance measure for a content item. The predicted performance measures can be used, along with bids for the content items, in an auction to select a content item to provide in response to a content item request.

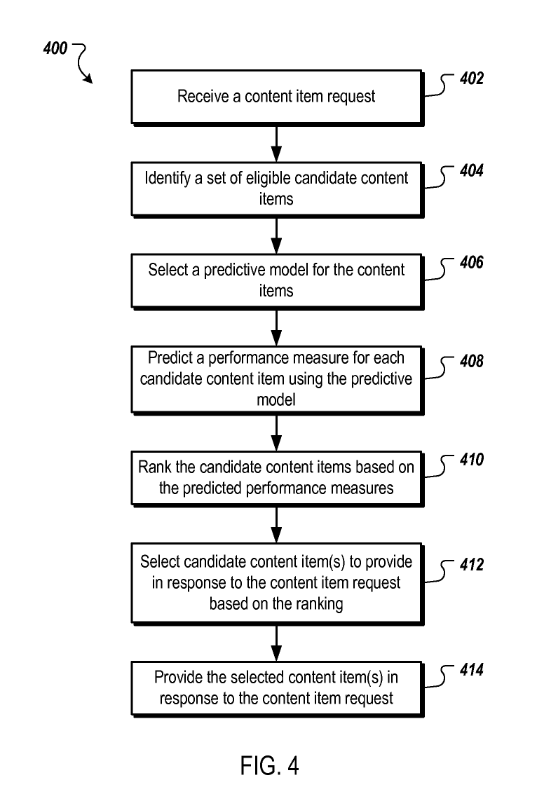

FIG. 4 is a flow chart of an example process 400 for providing a content item. Operations of the process 400 can be implemented, for example, by a data processing apparatus, such as the content distribution system 130 of FIG. 1. The process 400 can also be implemented by instructions stored on computer storage medium, where execution of the instructions by a data processing apparatus cause the data processing apparatus to perform the operations of the process 400.

A content item request is received (402). The content distribution system 130 may receive a content item request from a user device 106. For example, the user device 106 may have requested a resource 105 that has one or more content item slots (e.g., advertisement slots). In response to receiving the resource, the user device 106 transmits a content item request to the content distribution system 130. The content item request may include data regarding the resource 105 (e.g., keywords included in the resource 105), and/or the content item slot(s), and data specifying the number of content items requested. If the content item slots are for a search results page, the content item request may include keywords of a query for which search results are being provided.

A set of candidate content items is identified (404). The candidate content items are content items that are eligible to be provided in response to the content item request. For example, the eligible content items may be content items for which an advertiser has provided bids for keywords that match keywords of the resource 105 or submitted query. The candidate content items may be eligible based on a match or relevancy between the resource 105 or content item slots and the content items. For example, an advertiser 108 may bid on content item slots of resources that are related to particular categories or topics.

A predictive model 142 is selected for the candidate content items (406). A single predictive model 142 may be selected for the candidate content items, or multiple predictive models 142 may be selected. For example, if there is a predictive model 142 for each category of content items and there is more than one category of content items included in the set of candidate content items, then a predictive mode 142 may be selected for each category of content item.

The predictive model 142 may also be selected based on the number of content item slots that will be included in an auction for the resource 105. As described above, the loss functions can differ for single-slot auctions and multi-slot auctions. For example, loss functions (1)-(3) can be used for single-slot auctions, and loss functions (4) and (5) can be used for multi-slot auctions. Thus, the predictive models 142 generated using the loss functions 140 may differ based on the number of content item slots.

A performance measure is predicted for each candidate content item using the selected predictive model(s) (408). The performance predictor 132 may predict the performance measure for a candidate content item by applying the predictive model 142 to feature values for the candidate content item and/or feature values for the content item slots. The output of the predictive model 132 is the predicted performance measure for the candidate content item.

The candidate content items are ranked (410). The content distribution system 130 may rank the candidate content items based on a rank score for each candidate content item. The rank score for a candidate content item may be proportional to, or equal to, the product of the predicted performance measure for the candidate content item and a bid for the candidate content item.

One or more candidate content items are selected to be provided based on the ranking (412). If the auction is a single-slot auction, then the content distribution system 130 may select the candidate content item having the highest rank score. If the auction is a multi-slot auction, the content distribution system 130 may select a candidate content item for each slot based on the ranking. For example, the candidate content item having the highest rank score may be selected for the first content item slot, the content item having the second highest rank score may be selected for the second content item slot, and so on.

The selected content item(s) are provided in response to the content item request (414). The content distribution system 130 may provide the selected content item(s) to the user device 106 from which the content item request was received. In turn, the user device 106 can present the content items in content item slots of a resource 105.

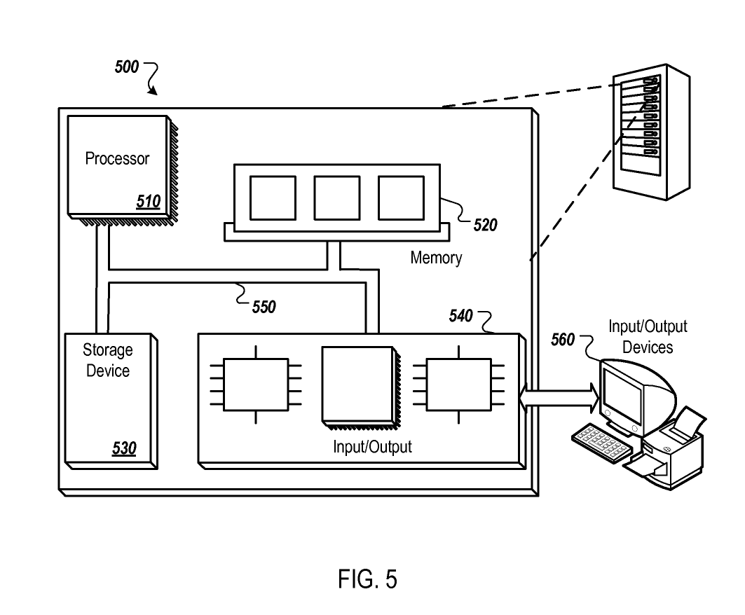

FIG. 5 is a block diagram of an example computer system 500 that can be used to perform operations described above. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (e.g., a cloud storage device), or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving a content item request;
identifying a set of candidate content items that are eligible to be provided in response to the content item request;
predicting a performance measure for each of one or more candidate content items based at least in part on a loss function that specifies an economic cost of incorrectly predicting the performance measure for the candidate content item, the loss function being based, at least in part, on a distribution of competing bid values for a set of previous content item impressions;
selecting a candidate content item for presentation based, at least in part, on the predicted performance measure for the one or more candidate content items; and
providing the selected candidate content item in response to the content item request.

2. The method of claim 1, further comprising selecting the loss function for the one or more candidate content items based on a category corresponding to the one or more candidate content items, wherein the distribution of competing bid values comprise bid values received for previous impressions of content items that were included in the category.

3. The method of claim 1, further comprising determining the loss function using an integral of the distribution of competing bid values for the set of previous content item impressions.

4. The method of claim 1, wherein the loss function is further based on a bid value for a particular candidate content item, the bid value for the particular candidate content item specifying a value a provider of the particular content item is willing to pay for user interaction with the particular candidate content item in response to the content item request.

5. The method of claim 3, wherein:
the content item request includes a request for a content item for display on a resource that includes two or more content item slots, and
the loss function generated for the particular content item is based on a set of probability values, each probability value being associated with a particular content item slot of the two or more content item slots and indicating a probability that a product of a predicted performance measure for the particular content item and the bid value for the particular content item is between a highest bid value for the particular content item slot and a next highest bid.

6. The method of claim 1, wherein the loss function specifies a greater economic cost for an under-prediction of the performance measure by a particular amount than an economic cost for an over-prediction of the performance measure by the particular amount for bid values that are greater than a threshold bid.

7. The method of claim 1, wherein the loss function specifies a greater economic cost for an over-prediction of the performance measure by a particular amount than an economic cost for an under-prediction of the performance measure by the particular amount for bid values that are less than a threshold bid.

8. The method of claim 1, further comprising selecting the loss function to train the predictive model from a set of loss functions based on a number of content item slots included on a resource for which the selected candidate content item is provided.

9. The method of claim 1, wherein predicting the performance measure for a particular candidate content item comprises:
identifying a predictive model that has been trained using at least the loss function to reduce an expected economic cost resulting from incorrectly predicting the performance measures for the content items; and
applying the predictive model to feature values of the particular content item, the feature values specifying features of the particular content item.

10. A system, comprising:
a data store for storing content items; and
one or more processors configured to interact with the data store, the one or more processors being further configured to perform operations comprising:
receiving a content item request;
identifying a set of candidate content items that are eligible to be provided in response to the content item request;
predicting a performance measure for each of one or more candidate content items based at least in part on a loss function that specifies an economic cost of incorrectly predicting the performance measure for the candidate content item, the loss function being based, at least in part, on a distribution of competing bid values for a set of previous content item impressions;
selecting a candidate content item for presentation based, at least in part, on the predicted performance measure for the one or more candidate content items; and
providing the selected candidate content item in response to the content item request.

11. The system of claim 10, wherein the one or more processors are further configured to perform operations comprising selecting the loss function for the one or more candidate content items based on a category corresponding to the one or more candidate content items, wherein the distribution of competing bid values comprise bid values received for previous impressions of content items that were included in the category.

12. The system of claim 10, wherein the loss function is further based on a bid value for a particular candidate content item, the bid value for the particular candidate content item specifying a value a provider of the particular content item is willing to pay for user interaction with the particular candidate content item in response to the content item request.

13. The system of claim 12, wherein:
the content item request includes a request for a content item for display on a resource that includes two or more content item slots, and
the loss function generated for the particular content item is based on a set of probability values, each probability value being associated with a particular content item slot of the two or more content item slots and indicating a probability that a product of a predicted performance measure for the particular content item and the bid value for the particular content item is between a highest bid value for the particular content item slot and a next highest bid.

14. The system of claim 10, wherein the loss function specifies a greater economic cost for an under-prediction of the performance measure by a particular amount than an economic cost for an over-prediction of the performance measure by the particular amount for bid values that are greater than a threshold bid.

15. The system of claim 10, wherein the loss function specifies a greater economic cost for an over-prediction of the performance measure by a particular amount than an economic cost for an under-prediction of the performance measure by the particular amount for bid values that are less than a threshold bid.

16. A computer storage medium encoded with a computer program, the program comprising instructions that when executed by data processing apparatus cause the data processing apparatus to perform operations comprising:
identifying a set of candidate content items that are eligible to be provided in response to the content item request;
predicting a performance measure for each of one or more candidate content items based at least in part on a loss function that specifies an economic cost of incorrectly predicting the performance measure for the candidate content item, the loss function being based, at least in part, on a distribution of competing bid values for a set of previous content item impressions;
selecting a candidate content item for presentation based, at least in part, on the predicted performance measure for the one or more candidate content items; and
providing the selected candidate content item in response to the content item request.

17. The computer storage medium of claim 16, wherein the instructions that when executed by data processing apparatus cause the data processing apparatus to perform further operations comprising selecting the loss function for the one or more candidate content items based on a category corresponding to the one or more candidate content items, wherein the distribution of competing bid values comprise bid values received for previous impressions of content items that were included in the category.

18. The computer storage medium of claim 16, wherein the loss function is further based on a bid value for a particular candidate content item, the bid value for the particular candidate content item specifying a value a provider of the particular content item is willing to pay for user interaction with the particular candidate content item in response to the content item request.

19. The computer storage medium of claim 18, wherein:
the content item request includes a request for a content item for display on a resource that includes two or more content item slots, and
the loss function generated for the particular content item is based on a set of probability values, each probability value being associated with a particular content item slot of the two or more content item slots and indicating a probability that a product of a predicted performance measure for the particular content item and the bid value for the particular content item is between a highest bid value for the particular content item slot and a next highest bid.

20. The computer storage medium of claim 16, wherein the loss function specifies a greater economic cost for an under-prediction of the performance measure by a particular amount than an economic cost for an over-prediction of the performance measure by the particular amount for bid values that are greater than a threshold bid.
